(19) United States
(12) Patent Application Publication
(10) Pub. No.: US 2026/0110529 A1
(43) Pub. Date: Apr. 23, 2026

(54) REFLECTIVE FOCUSED LASER DIFFERENTIAL INTERFEROMETER

(71) Applicant: Government of the United States as represented by the Secretary of the Air Force, Wright-Patterson AFB, OH (US)

(72) Inventors: Jonathan Hill, Oakwood, OH (US); Ahsan Hameed, Centerville, OH (US); Matthew Borg, Beavercreek, OH (US)

(21) Appl. No.: 19/343,426

(22) Filed: Sep. 29, 2025

Related U.S. Application Data
(60) Provisional application No. 63/710,770, filed on Oct. 23, 2024.

(51) Int. Cl. G01B 9/02015

(52) U.S. Cl. CPC G01B 9/02015

(57) ABSTRACT

A reflective focused laser differential interferometry (R-FLDI) system includes: a light source for generating a beam of light; a beam expanding optic; a first linear polarizer; a quarter-wave plate; a first birefringent prism; a beam discriminating optic; a focusing lens; a reflector; a second birefringent prism; a second linear polarizer; and a detector. In a first pass, the beam of light passes through the plano-concave lens, the first linear polarizer, the quarter-wave plate, the first birefringent prism, the beam discriminating optic, and the focusing lens such that it propagates through a measurement location, after it passes through the measurement location, it is reflected by the reflector such that it passes through the focusing lens and is redirected by the beam discriminating optic through the second birefringent prism and a second linear polarizer and is detected by the detector.

### CROSS-REFERENCE TO RELATED APPLICATIONS

Pursuant to 37 C.F.R. § 1.78 (a)(4), this application claims the benefit of and priority to prior filed co-pending Provisional Application Ser. No. 63/710,770, filed Oct. 23, 2024, which is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to focused laser differential interferometry and, more particularly, to a reflective-focused laser differential interferometer.

### BACKGROUND OF THE INVENTION

Focused laser differential interferometry (FLDI) is a non-intrusive optical technique that measures the difference in optical path length between an interfering beam pair. It features excellent spatial and temporal resolution (for example, 100 μm and 10 MHz, respectively) and high sensitivity. FLDI can be utilized to obtain high bandwidth, non-intrusive measurements in facilities such as wind tunnels to make reliable measurements of convective velocity between two closely spaced FLDI probe volumes, disturbance-level characterization, and has been widely adopted in hypersonic ground testing and other high-speed applications (e.g., supersonic aerodynamics, jet dynamics, propulsion systems, plumes/wakes, shock waves, etc.).

Traditional FLDI has been adapted into variants that each provide unique measurement capabilities. One of the primary limitations of traditional FLDI instruments is that they are typically only able to provide measurements at a single point during a test. To overcome this limitation, some variants of FLDI create multiple measurement locations. This is achieved through the use of additional beam-splitting optics (typically birefringent prisms or diffractive optical elements), which can be introduced into the optical path of the setup to create multiple, focused, beam pairs in the test region. These multi-point FLDI setups are typically referred to as double-FLDI (D-FLDI), two-point-FLDI, or linear-array-FLDI (LA-FLDI). The focusing optical path of traditional FLDI also can limit the instruments utility over wide, flat geometries where the walls of the test article can intrude on the beam's propagation. To overcome this limitation, a cylindrical lens can be utilized in the FLDI optical path to flatten the beam pair along one of the dimensions as it is focused down. This variant is typically referred to as cylindrical-FLDI (C-FLDI).

All of the traditional variants of FLDI require “pitch” optics (the aspects of the optical system associated with generating a beam) and separate “catch” optics (the aspects of the optical system associated with receiving the beam) set up on either side of the measurement location. Therefore, to incorporate a traditional FLDI setup in ground testing facilities (e.g. wind tunnels), two points of optical access are required, typically located on either side of the test region with the measurement location positioned within the optical line-of-sight. This often limits the number of available measurement locations a traditional FLDI setup can access. Additionally, the nature of having two separate optical setups on either side of the test region requires precise alignment between the pitch and catch sides for a traditional FLDI to properly function. This requirement for precise alignment makes traditional FLDI arrangements susceptible to vibrations and oscillations that often occur during or between tests, making it challenging to get consistent and repeatable results using a traditional FLDI setup, especially at facilities with large impulses or vibrations (e.g., shock tunnels, propulsion facilities, etc.) The reflective-FLDI (R-FLDI) systems and features described herein would solve one or more problems encountered in the current state of the art.

### SUMMARY OF THE INVENTION

The present invention overcomes the foregoing problems and other shortcomings, drawbacks, and challenges of FLDI systems. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a reflective focused laser differential interferometry (R-FLDI) system includes: a light source for generating a beam of light; a beam expanding optic; a first linear polarizer; a quarter-wave plate; a first birefringent prism; a beam discriminating optic; a focusing lens; a reflector; a second birefringent prism; a second linear polarizer; and a detector. In a first pass, the beam of light passes through the plano-concave lens, the first linear polarizer, the quarter-wave plate, the first birefringent prism, the beam discriminating optic, and the focusing lens such that it propagates through a measurement location, after it passes through the measurement location, it is reflected by the reflector such that it passes through the focusing lens and is redirected by the beam discriminating optic through the second birefringent prism and a second linear polarizer and is detected by the detector.

According to another embodiment of the present invention, a method of measuring optical path length differences using a R-FLDI system includes: directing a spectrally narrow, diverging, continuous wave laser beam in a circular polarization state of arbitrary handedness along a primary optical axis in a first direction; separating the circularly polarized beam into a linearly polarized beam pair with orthogonal polarization through the first birefringent prism in the first direction; passing the linearly polarized beam pair through a focusing lens in the first direction; passing the converging, polarized beams of the beam pair through a measurement region a first time in the first direction; reflecting the diverging, polarized beam pair back along the primary optical axis in a second direction; passing the reflected diverging, polarized beam pair through a measurement region a second time in the second direction; passing the reflected, diverging, polarized beam pair a second time through a focusing lens in the second direction; diverting the reflected, converging beam pair along a secondary optical axis that is at an angle from the primary optical axis; combining the diverted beam pair into a single beam with orthogonal polarization states using a second birefringent prism along the secondary optical axis; projecting the orthogonal polarization states of the recombined, single beam onto the same polarization axis using a polarizing optic along the secondary optical axis; and measuring the intensity of the diverted, combined beam.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 shows a dual-sided focused laser differential interferometry (FLDI) system of the prior art.

FIG. 2A shows an embodiment of a reflective focused laser differential interferometry (R-FLDI) system, specifically a first pass of a laser of the R-FLDI system.

FIG. 2B shows a second pass of the R-FLDI system of FIG. 2A.

FIG. 3 shows another embodiment of an R-FLDI system.

FIG. 4 shows a picture of the FLDI beam pairs.

FIG. 5 shows an R-FLDI system with a mirror and a light block.

FIG. 6 shows broadband RMS voltage results for experiments performed with various FLDI configurations.

FIG. 7 shows power spectral density contour maps for various FLDI configurations.

FIG. 8 shows power spectral density amplitudes at distinct frequencies plotted against jet distance from an FLDI focus.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

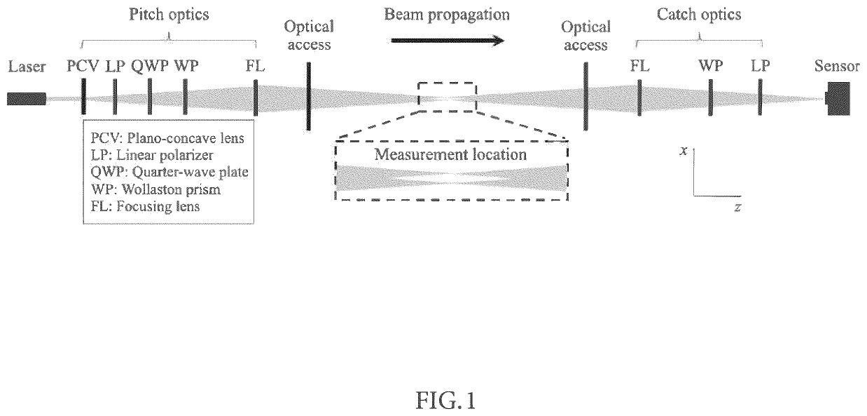

FIG. 1 shows a traditional, dual-sided FLDI of the prior art. A traditional FLDI allows for the measurement of optical path length difference between an interfering beam pair and density gradient fluctuations via the manipulation of polarization states and focusing optics to form a common-path interferometer. FIG. 1 shows a diagram of a traditional FLDI setup, with the pitch-side and catch-side optics identified. The FLDI of FIG. 1 requires at least two optical accesses to access the components of the FLDI. Beginning on the pitch side, a spectrally narrow, collimated, continuous wave laser beam of small diameter (on the order of <1 mm) and arbitrary polarization state is required. Following the beam path, this beam is then expanded using an expanding optic (e.g., a plano-concave lens). If the expanding beam is not already circularly polarized, polarizing optics (e.g., a linear polarizer and a quarter-wave plate) are used to achieve circular polarization of arbitrary handedness. This circularly polarized, expanding beam is next passed through a birefringent prism (typically a Wollaston prism) to split the single beam into a pair of orthogonally-polarized beams, one with vertical polarization and the other with horizontal polarization. The separation angle of the birefringent prism is typically small (on the order of arcminutes), such that the two, orthogonally polarized beams are nearly concentric as they continue to expand. A focusing lens (e.g., a plano-convex lens or an achromatic doublet) is then used to focus the expanding beam pair to a point at the center of the desired measurement location. The location of the focus relative to the focusing lens is dependent on the focal lengths and distance between the expanding and focusing optics. While the two orthogonally-polarized beams within the beam pair remain largely concentric for a majority of their individual paths, as the beam pair approaches the measurement location, their beam diameters decrease and, thus, their spatial overlap decreases. At the measurement location, the beams within the beam pair are separated by a finite spacing perpendicular to the beam propagation direction. The separation distance of the beams within the beam pair is dependent on the birefringent prism separation angle, the distance between the birefringent prism and the focusing lens, and the distance to the focal points from the focusing lens. The angular orientation of the beam pair at the focus is dependent on the rotation of the birefringent prism about the primary light propagation axis.

The catch-side optics of a traditional FLDI are generally mirrored about the focus. Down beam of the focus, the beams re-expand and their spatial overlap increases. Another focusing lens is used to focus the expanding beams. A birefringent prism of similar design and material as the one on the pitch side (e.g., equal separation angle, etc.) as the one on the pitch side, is placed at approximately the same distance from the catch-side focusing lens as the relative distance between the pitch-side focusing lens and birefringent prism, and is used to recombine the two beams in the beam pair. Although spatially recombined, these beams maintain orthogonal polarization with respect to each other. Finally, the addition of a linear polarizer, oriented at 45°, generates interference between the beams.

Depending on the angular orientation and location of the catch-side birefringent prism and linear polarizer, fringe patterns can be observed across the beam's diameter if it is projected onto an observation plane. The angle and position of the birefringent prism and polarizer should be adjusted until the “infinite fringe” position is achieved. Once the infinite fringe is achieved, translating the birefringent prism perpendicular to the beam propagation axis results in the entire beam's interference shifting in phase between minimum interference (brightest beam) to maximum interference (dimmest beam). A high-bandwidth sensor (e.g., a photodetector, etc.) should then be placed down beam of the recombined beams, typically near the focus. Shifting the phase of interference by traversing the birefringent prism across the beam path will then result in voltage changes measured by the sensor. The birefringent prism should be set to approximately halfway between the maximum and minimum interference, where the instrument's response is approximately linear (i.e., a change in phase of one of the two beams will result in an approximately linear change in voltage at the detector).

In some applications of FLDI, local changes in the fluid's density result in local changes in the index of refraction. If only one beam in the FLDI beam pair experiences this local gradient in density, an optical path length difference is introduced, resulting in a phase difference between the individual beams in the FLDI beam pair. For most of the beam propagation path, where the diameters of the beams within the beam pair are relatively large and overlapping, the phase shift of the two beams due to density gradients is nearly identical. These common phase shifts between the two beams will result in negligible effects on interference and thus make the interferometer insensitive to density gradient fluctuations in these regions. Within the measurement region and near the beam's focus, the lack of overlap and small diameter of the two beams means that each beam passes through a slightly different region of the fluid density field, which can have differing indices of refraction. Any changes in optical path length between the two beams in this region near the focus results in a phase difference between the two beams, which manifests as a measurable shift in interference at the sensor and is registered as a voltage change. Connecting the sensor to a data acquisition system allows for high-bandwidth measurements of density-gradient fluctuations at the focal point of the FLDI setup. The sample rate for FLDI is only limited by the response time of the sensor and the bandwidth of the data acquisition system.

As mentioned above, traditional dual-sided focused laser differential interferometer (FLDI) systems have limitations. To address these limitations, for example limitations associated with having separate pitch and catch optics, a new reflective FLDI (R-FLDI) instrument is proposed which introduces a reflective surface, such as a mirror or retroreflector, into the FLDI beam path. This reflective surface enables a single-sided placement of pitch and catch optics. With this design, only a single point of optical access is required to achieve measurements. R-FLDI also provides practical improvements over traditional FLDI: it is easier to align and is more resistant to vibrations during testing than traditional FLDI setups. Additionally, R-FLDI enables a significantly wider range of measurement locations to be explored. A measurement location using R-FLDI should be within line-of-sight of the single, optical-access point and the reflective surface should be mounted along the desired beam path, past the measurement location. These advantages of R-FLDI enable non-intrusive measurements at locations not previously achievable using conventional setups. This is of particular interest for high-speed supersonic and hypersonic aerodynamic testing where non-intrusive, high-bandwidth measurements are crucial across the design cycle of relevant technologies.

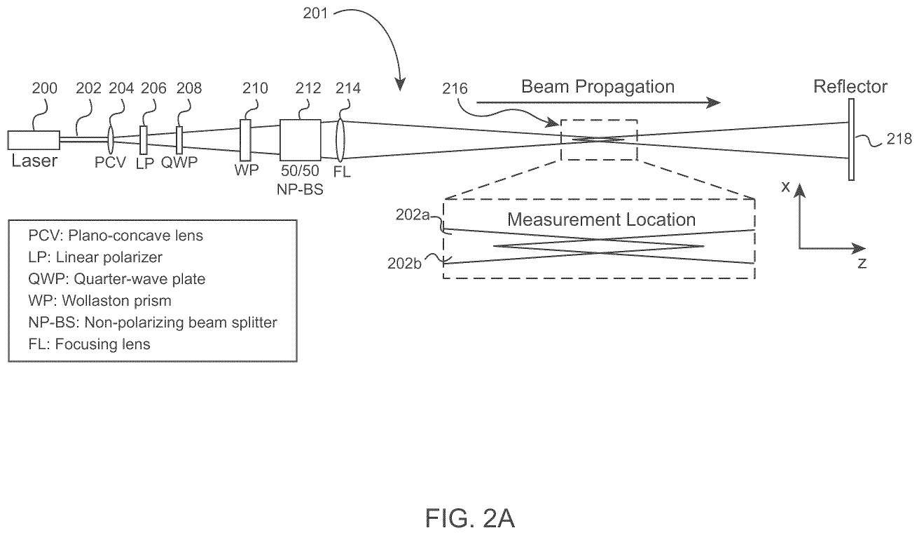

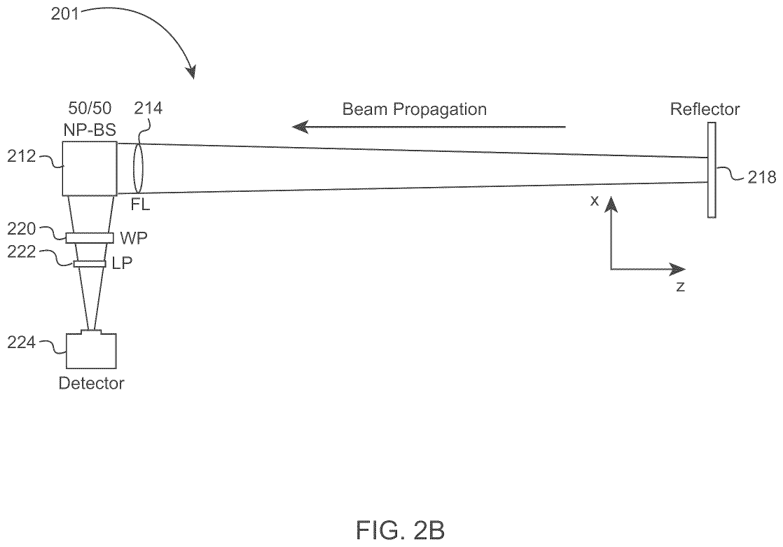

FIG. 2A and FIG. 2B show an embodiment of an R-FLDI system 201 of the present disclosure. FIG. 2A shows a first pass (or a forward pass) of emitted light from a light source 200 (e.g., a laser). The light source 200 emits a beam 202. The R-FLDI system 201 further includes a beam expanding optic 204 (e.g., plano-concave lens (PCV), etc.), a first linear polarizer (LP) 206, a quarter-wave plate (QWP) 208, a first birefringent prism 210 (e.g., a Wollaston prism (WP)), a beam discriminating optic 212 (e.g., a non-polarizing beam splitter (NP-BS), etc.), a focusing lens (FL) 214, a measurement location 216 (where the beam 202 may be split into a first beam 202a and a second beam 202b), and a reflector 218. FIG. 2B shows additional aspects of the system 201 during a second pass (e.g., a reflected pass of the beam 202 of the reflector 218). FIG. 2B includes the reflector 218, the focusing lens 214, the discriminating optic 212, a second birefringent prism 220 (e.g., a second WP), a second linear polarizer (LP) 222, and a detector 224. The R-FLDI may only require a single optical access to access applicable components.

As shown, the forward pass of the R-FLDI system 201 shares the beam expanding, polarizing, splitting, and focusing optics that are used on the pitch-side of a traditional FLDI. Down beam of the first birefringent prism 210, an R-FLDI setup produces a pair of orthogonally polarized beams 202a, 202b with a prescribed spatial displacement or angular separation between them. In an R-FLDI setup, following the birefringent prism, the discriminating optic 212 (e.g., a 50/50 non-polarizing beam splitter) is placed in the beam path. The discriminating optic 212 allows a fraction (e.g., half) of the light to continue through in the forward pass while the other half is rejected into a beam dump. Similar to a traditional FLDI setup, the transmitted light is focused at the measurement location 216, after which the beam pairs continue to increase in diameter and spatial overlap. The measurement location 216 can measure, for example, a density disturbance field.

The first LP 206 can allow only light with a specific polarization orientation to pass through, while blocking or absorbing light with other polarization orientations. The result is that the transmitted light is linearly polarized, meaning that its electric field oscillates in a single plane. Unpolarized light, such as sunlight or most artificial light, consists of waves oscillating in all directions perpendicular to the direction of travel. A linear polarizer can filter this light so that only the components oscillating in one specific direction are allowed through. The polarizer works by using materials that absorb or reflect light polarized in one direction and transmit light polarized in the perpendicular direction. The linear polarizer 206 can be an absorbative polarizer, a dichroic polarizer, a reflective (or “beam splitting polarizer”) or a birefringent polarizer. The absorbative polarizer can use materials that selectively absorb light polarized in one direction. Light polarized parallel to the molecular alignment is absorbed, while light polarized perpendicular to it passes through.

The QWP 208 can be an optical device retards one component of polarization with respect to its orthogonal component by a retardation value of 24 . . . . The QWP 208 can be made from a birefringent material, which has different refractive indices for light polarized along two perpendicular axes (called the fast axis and the slow axis). When light passes through QWP 208, the component of the light that is polarized along the slow axis is delayed relative to the component along the fast axis. The fast axis is the direction where the refractive index is lower, so light travels faster. The slow axis is the direction where the refractive index is higher, so light travels slower.

If linearly polarized light enters the QWP 208 at a 45-degree angle to the optical axes (fast and slow axes), the phase shift between the two orthogonal components will transform the light into circularly polarized light (either left-handed or right-handed, depending on the orientation of the fast and slow axes). Conversely, the QWP 208 can convert circularly polarized light into linearly polarized light. When circularly polarized light enters the wave plate, the phase shift aligns the orthogonal components in such a way that the output is a linearly polarized beam. When light that is not perfectly aligned with the fast or slow axis passes through the QWP 208, it may become elliptically polarized, which is a more general form of polarization where the tip of the electric field vector traces an ellipse in the plane perpendicular to the direction of propagation. The QWP 208 can utilize quartz (SiO₂), calcite (CaCO₃), and/or one or more polymer films.

The first birefringent prism 210 can be an optical device that utilizes birefringence (i.e., double refraction) to manipulate light (e.g., the beam 202) by splitting it into two separate polarized beams. Birefringence can occur based on the first birefringent prism 210 having different refractive indices for different polarization states of light, causing the light to split into ordinary and extraordinary rays. The first birefringent prism 210 can have two refractive indices: one for light polarized along the “ordinary” axis (the o-ray) and another for light polarized along the “extraordinary” axis (the e-ray). Key components of the birefringent prism 210 are the two, specially cut prisms made of birefringent material. The material selection, arrangement, and prism orientation affect the prism's function.

Birefringent prisms can be made from anisotropic materials like calcite (CaCO₃), quartz (SiO₂), or magnesium fluoride (MgF₂). These materials have different refractive indices depending on the polarization direction of the incoming light. Calcite can be used due to its strong birefringence. The optical axes in birefringent materials are key to their operation. As alluded to, the optical axes can include an ordinary axis and an extraordinary axis. Light polarized along the ordinary axis behaves differently from light polarized along the extraordinary axis. The difference in refractive indices between these two axes causes the light to split.

As mentioned above, the first birefringent prism 210 can be a Wollaston prism. The Wollaston prism consists of two birefringent prisms (usually made of calcite or quartz) cemented together at a specific angle. The light entering the prism is split into two orthogonal, linearly polarized beams that diverge at a specific angle, determined by the prisms' wedge angle and the wavelength of the light. Other types of prisms can include a Sanderson prism, a Rochon prism, or a Nomarski prism. The Sanderson prism can be made from a polycarbonate material that exhibits a stress-induced birefringence, with the divergence angle determined by the load applied to the prism. The Rochon prism can be made from birefringent material, similar to a Wollaston prism. The Rochon prism can be useful when one beam needs to remain undeviated and the other to be separated. The Nomarski prism can be a variation of a Wollaston prism, consisting of two birefringent crystal wedges cemented together, with the second wedge modified by cutting the crystal so the optical axis is oriented obliquely, causing the light rays to come to a focal point outside of the body of the prism.

The discriminating optic 212 can be an optical device designed to divide a beam of light into two separate beams, but unlike polarizing beam splitters, it can split the light without separating it based on polarization. This means that both components of light (s-polarized (perpendicular) and p-polarized (parallel)) can be reflected or transmitted in a way that the polarization state of the light remains essentially unchanged. The discriminating optic 212 can be an NP-BS. Key characteristics of a NP-BS can be the non-polarization dependency, splitting ratio, and coatings and materials, with the main requirement being that it doesn't alter the polarization states of the incoming light. The NP-BS may be designed to split light into two beams with specific intensity ratios (typically 50:50). The NP-BS may use specialized coatings or materials that provide equal or near-equal reflection and transmission for both polarization states across a particular wavelength range (e.g., 400-700 nm, 700-1100 nm, 1100-1600 nm, etc.). Coatings for the NP-BS can include dielectric multilayer coatings, which may consist of alternating layers of materials with different refractive indices that produce total internal reflection, which causes a portion of the light to be reflected and the rest to be transmitted. Regarding the materials for the NP-BS, substrate material for the NP-BS must be optically transparent and stable across the wavelength range of interest. Some possible materials can include: fused silica, BK7 glass, and other low-absorption optical glasses.

The discriminating optic 212 can also be a D-shaped pickoff mirror. Key characteristics of a D-shaped pickoff mirror are its semi-circular base and a precisely cut straight edge, with the reflective coating extending near the straight edge. The D-shaped pickoff mirror can be made from fused silica, with the reflective coating chosen based on the application. If a D-shaped pickoff mirror is used, then care must be taken to ensure the mirror transmits 50% of the light on the forward path and diverts 50% of the light on the return path.

Coatings of the discriminating optic 212 can include dielectric multilayer coatings, which may consist of alternating layers of materials with different refractive indices. These layers can create interference effects that can be fine-tuned to achieve nearly equal reflectance and transmittance for both polarization states. The choice of materials for these layers (such as silicon dioxide (SiO₂) and titanium dioxide (TiO₂)) and their thicknesses determine the optical properties of the NP-BS. The coating's thickness and refractive indices can be adjusted for specific wavelengths (or a range) to minimize polarization-dependent losses.

The beam dump can be a device or structure used to safely absorb and dissipate the energy of a high-energy particle or laser beam, preventing it from causing damage or unintended interactions. The beam dump can be used to scatter and/or terminate the beam 202 in a controlled manner without scattering harmful radiation or damaging equipment. In some embodiments, the beam dump can exhibit one or more key characteristics such as energy absorption, heat dissipation, aspects of its material composition, and shielding. In some embodiments, the beam dump can be designed to absorb the kinetic or electromagnetic energy from the beam and convert it into heat or other forms of energy.

In the R-FLDI system 201, the reflector 218 is introduced along the beam path after the focus. This reflector 218 can be, for example, a specular reflector (e.g., a mirror or polished surface) or a specular retroreflector (e.g., corner cube prisms or hollow retroreflectors). To produce the best measurements, the desired qualities for this reflective surface are: 1) it must not destroy the spatial phase coherency of the two beams, 2) it must reflect an equal amount of the two beams, and 3) it must reflect a majority of the two beams (i.e., the reflector diameter should be larger than the beam diameters at the reflector's location). If the reflective surface is rough or is designed in such a way that the optical path lengths of the reflected rays across the diameter of the beam pair are not equal, then there will be an arbitrary phase distribution in the beams as they continue to propagate on the return pass, and the spatial phase coherency will be lost.

The specular reflector can be a surface or object designed to reflect light in a specific, mirror-like manner. It reflects incident light rays at a definite angle, preserving the angles of incidence and reflection according to the law of reflection (angle of incidence=angle of reflection). Key characteristics of a specular reflector include: smoothness, mirror-like reflection, and limited diffusion. The surface must be extremely smooth, often polished, to reflect light uniformly without scattering. Light reflected from a specular reflector maintains the image or pattern of the light source, just as a mirror reflects a clear image. Unlike diffuse reflectors, which scatter light in many directions, a specular reflector sends light in a predictable, controlled direction with limited diffusion. Common examples of specular reflectors can include mirrors, polished metal surfaces, and certain specialized coatings used in optical and lighting systems, where controlling the direction of reflected light is important. Specular reflectors are used in various applications, such as telescopes, lasers, and lighting systems, to direct light efficiently.

The specular retroreflector can be a device or surface that reflects light back toward the source along the same path it came from over a broad range of incidence angles. Unlike specular reflectors, which reflect light at an angle equal to the angle of incidence, a specular retroreflector returns the light to its origin. Key characteristics of the specular retroreflector can include: directional reflection, acceptance of a wide range of input angles, and retroreflector design. Specular retroreflectors can be corner cube retroreflectors. A corner cube retroreflector is composed of three mutually perpendicular reflective surfaces that form the inner corner of a cube. When an incident beam strikes the retroreflector, it undergoes three reflections, resulting in the output beam traveling parallel to the input beam but in the opposite direction.

If a specular reflector is used, such as a mirror, then care must be taken to ensure the reflective surface is perpendicular to the direction of beam propagation so that the primary axis of the propagating beam reflects towards the original focusing lens. Using a specular reflector, the beam pair will continue to expand as it propagates back towards the focusing lens. If an ideal retroreflective device could be utilized, then all the rays of the incident beam pair would be reflected back along the incident path, irrespective of the angle of incidence, and would refocus back down to the desired point of focus within the measurement region. True retroreflectors, however, cannot perfectly retroreflect large, expanding beams. Instead, they ensure the reflected beam's axis remains aligned with the incident beam's axis (up to the retroreflector's specified maximum incidence angle) while allowing the beam to continue to expand in a similar fashion to a specular reflector. In this way, the use of a retroreflector removes the need for the reflector surface to be perfectly perpendicular with the beam propagation axis and increases the vibrational resistance of R-FLDI.

In embodiments utilizing a retroreflector, the incident beams may be centered on the retroreflector's vertex, such that the beams are distributed equally across the three faces of the retroreflector. Positioning part or all of the incident beams away from the retroreflector's vertex displaces the returning beam from the incident beams' axis of propagation and may limit the performance of the R-FLDI instrument or require additional optics to collect the expanding beams on their return path. The positioning of the reflective surface along the beam path is dependent on practical considerations. For example, the reflective surface must be positioned far enough away from the measurement region such that it does not disturb the measurement itself. Furthermore, if the measurement location is over the surface of a model (e.g., a cone or cylinder), the positioning of the reflective surface will be limited by the physical size and shape of the model. While the reflective surface may be placed a reasonable distance away from the beam focus (limited to the distance between the focusing lens and the focus), the size of the expanding beams should be considered, which may grow to three times their maximum diameter at the focusing lens on their return path. If the diameter of the returning beam pair is larger than the aperture of the chosen focusing lens, then light will be lost and a reduction in signal will occur. For this reason, the diameter of the beams as they propagate through the focusing lens on the forward pass may need to be sacrificed to fully capture the returning beams. Alternatively, the reflective surface may be positioned closer to the focus. Quality lenses, which limit spherical and chromatic aberrations, are recommended in an R-FLDI setup, and may also be used for the focusing lens to mitigate these effects and allow the diameter of the incident and returning beams to be optimized.

Following their return pass through the focusing lens, the diameter of the returning beams begins to decrease. The beams are next passed back through the 50/50 non-polarizing beam splitter-some of the returning light passes straight through the beam splitter and is lost while the rest of the light is turned 90 degrees along the secondary optical axis and continues to focus down. The second birefringent prism and a linear polarizer is introduced in the beam path along the secondary optical axis. The optical properties of this second birefringent prism should match the first birefringent prism's specifications. The separation angle of this second birefringent prism should match the first prism's specifications. The rotational orientations and locations along the secondary axis of the birefringent prism and the linear polarizer are dependent on the first birefringent prism in the setup. As the two beams pass through the second birefringent prism, they are recombined. As the recombined beams pass through the linear polarizer, they begin to interfere, which is registered as a voltage change measured by the detector 224.

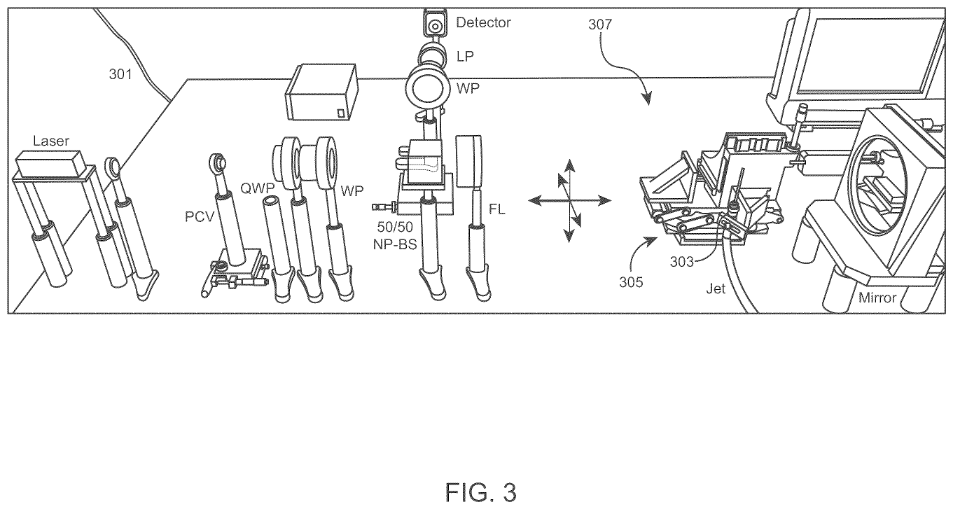

FIG. 3 shows an exemplary R-FLDI system 301 which is one potential embodiment of the R-FLDI system 201 schematically represented in FIG. 2 and incorporates its components as shown in FIG. 3. The R-FLDI system 301 is set up to measure a flow from a jet 303. The mounting, maneuvering, and positioning of each of the individual components of the R-FLDI system 301 can be adjusted based on user needs. While each component can be mounted independently, in some embodiments, all the optics that compose the primary apparatus can be mounted onto a common stiff structure (e.g., optical breadboard, optical rail, etc.) to increase stability and maintain alignment. In some embodiments, the optics may be attached to linear translation stages to enable precise alignment and positioning of the focus in the test region. Each of the optics in the R-FLDI system should be centered and concentric such that the beam path is not significantly steered or distorted by any one optical component. The exact specifications of the continuous wave laser used in the R-FLDI setup may vary. One requirement for the laser is that the output power be high enough to produce a viable signal at the sensor without damaging any of the optical components. The light source used in the R-FLDI setup may be, for example, a continuous wave laser producing a TEM00 beam profile with an output power high enough to produce a viable signal at the sensor without damaging any of the optical components. A laser of this designation may provide sufficient focusing ability and reduce undesired beam divergence.

A broadband signal amplifier can also be used if the sensor's output voltages are too low. In some embodiments, anti-reflection (AR) coated optical components can be used to reduce losses and extraneous reflections in the optical setup. The frequency resolution of R-FLDI can depend on the response time of the sensor and the bandwidth of the data acquisition system. Hence, a relatively fast-response sensor and a high-bandwidth data acquisition system can be utilized. The bit-depth of the data acquisition system is a factor in the amplitude resolution of R-FLDI, and embodiments may utilize a relatively large bit-depth for good resolution.

The jet 303 may be affixed to a combination of translation stages 305, precisely controlling adjustments in the x, y, and z directions. A dial indicator attached to the optical table using a magnetic base can be used to record the position of the jet 303 as it is translated through an R-FLDI foci 307 along the beam propagation axis. The jet 303 can provide the flow of fluid (e.g., air) to measure localized density gradient fluctuations within the fluid using the R-FLDI system described herein.

The optical components used in R-FLDI can, in some embodiments, be interchangeable with other, off-the-shelf or custom variants as long as the primary function of the optic is retained. An example of this is the 50/50 non-polarizing beam splitter, which can be, for example, a beam-splitting cube or a beam-splitting plate.

Various, non-limiting example tests are discussed herein. Aspects of these tests are exemplary only, and various embodiments of the systems and methods disclosed herein may utilize different settings, equipment, and other features according to the various criteria laid out herein. In some example benchtop tests, for instance, the performance of R-FLDI to a traditional FLDI can be compared. Comparisons between a traditional FLDI and variations of R-FLDI instruments can be made, for example, one using a mirror as a reflective surface and the other using a retroreflector.

A jet can be used to generate a density disturbance field (e.g., one with an exit diameter of 2.4 mm (e.g., McMaster-Carr part number 5446K72)). The jet may be placed 17.5 mm (˜7.3 exit diameters) below the focus of the FLDI setups and can be translated along the beam propagation axis from −25.4 mm to 25.4 mm across the beam pair focal point using a linear stage at an interval of 2.54 mm (positive direction being further from the pitch-side focusing lens) measured by a digital dial indicator (e.g., a CDI Chicago BG2820 digital dial indicator) attached to the optical table using a magnetic base. The jet can be supplied with compressed air from an air compressor regulated to approximately 30 PSIG.

To prevent fluctuations in pressure or vibrations from affecting results, the air compressor's tank pressure can be maintained above 80 PSIG. A physical stop can be positioned at the most up-beam location of the jet travel to allow repeatability of results between experiments. The signal can be collected at a sample rate of 50 MHz for 20 ms per test. In some embodiments, the dominant frequency of the jet may be approximately 20 kHz which corresponds to approximately 400 dominant oscillations being captured in the run time of each test.

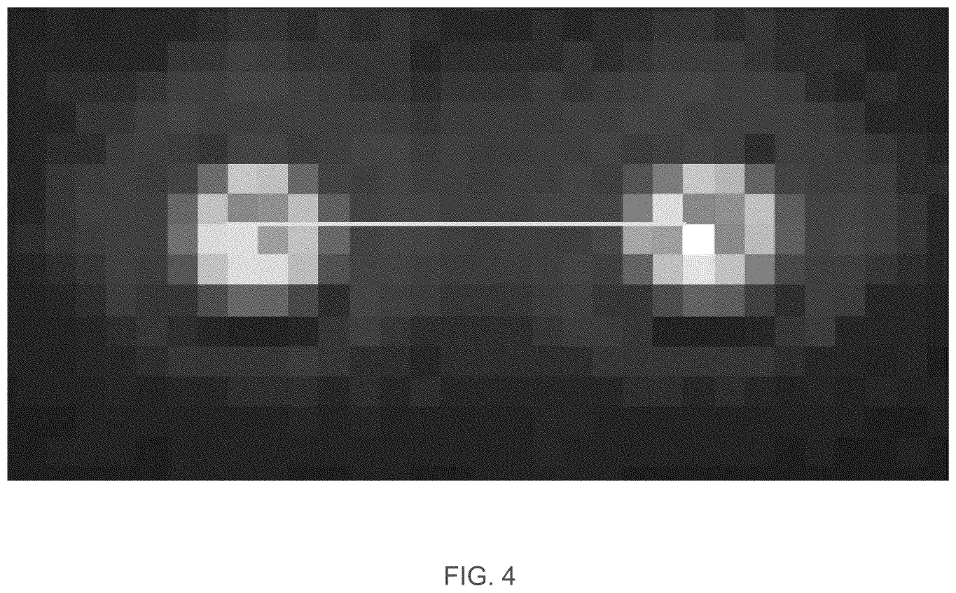

The R-FLDI beam pairs can probe the exit of the jet, and may be separated horizontally across the jet's diameter to measure spanwise density gradient fluctuations. A picture of the R-FLDI beam pairs taken using a Thorlabs BC106N-VIS CCD camera beam profiler is presented in FIG. 4. In the particular embodiment, the spacing between the beam pairs was measured to be approximately 97 μm. During testing, the location and orientation of the pitch optics of the traditional FLDI setup were maintained between setups.

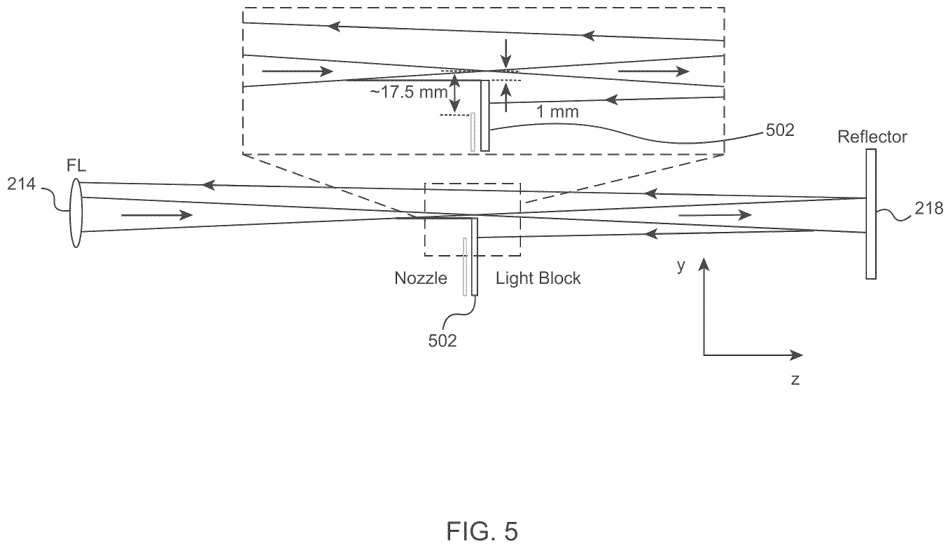

Table 1 summarizes various experimental configurations capable of being implemented based on the aspects of systems described herein. Each configuration represents a different setup of a traditional FLDI instrument or a R-FLDI instrument, with the traditional FLDI setup used as the control. To avoid over-saturation of the Thorlabs PDA36A2 photodetector used to measure voltage change in these experiments, the traditional FLDI setup in configuration 1 used a Thorlabs NE04A neutral density filter with an optical density of 0.4 placed immediately at the output of the laser. Configurations 2 and 3 featured the R-FLDI instrument using a mirror or a retroreflector as the reflecting surface. The retroreflector utilized in configuration 3 is an Edmund Optics 76.2 mm mounted corner cube retroreflector (part number 49-081). The neutral density filter used in configuration 1 was maintained in these R-FLDI configurations. In configuration 4, the neutral density filter was removed from the setup in an attempt to match the R-FLDI instrument's broadband peak voltage root-mean-square (RMS) values to those of the traditional FLDI setup in configuration 1. In configuration 5, the R-FLDI instrument's response to moving the reflective surface further away from the focus was tested. In configuration 6, the R-FLDI setup is the same as that in configuration 2, but a light block (see, for example, the light block 502 of FIG. 5) is positioned adjacent to the jet exit, or nozzle, to simulate the beams in an R-FLDI instrument passing above a model's surface. For clarity, a depiction of this configuration is presented in FIG. 5.

TABLE 1
Benchtop Test Configurations

| Configuration | Configuration Description | Notes |
|---|---|---|
| 1 | Traditional FLDI | |
| 2 | R-FLDI with mirror | |
| 3 | R-FLDI with retroreflector | |
| 4 | R-FLDI with mirror matching | Same setup as 2, but laser power is |
| | peak RMS | adjusted to compensate for losses in R- |
| | | FLDI setup and match the peak voltage |
| | | RMS values of the traditional FLDI |
| | | setup in #1 |
| 5 | R-FLDI with mirror at | Same setup as 2, but the mirror is |
| | increased distance | approximately 2x further from the focus |
| 6 | R-FLDI with mirror and light | Same setup as 2, but a light block is |
| | block | used to simulate a near-wall |
| | | measurement |

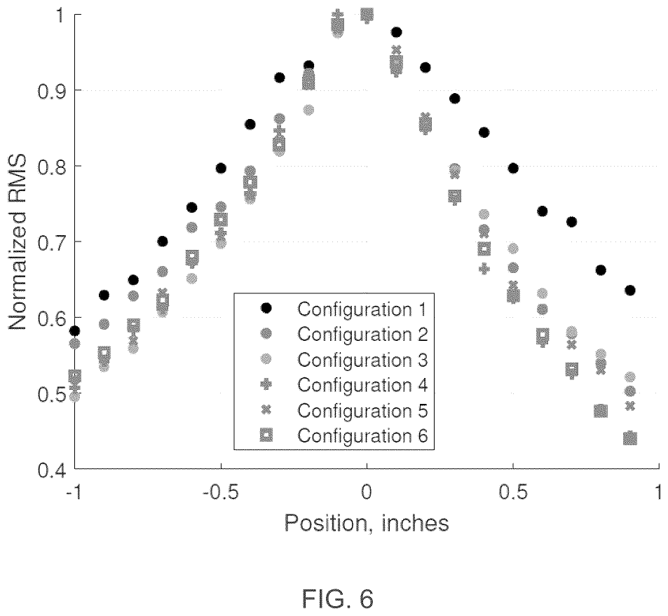

FIG. 6 presents the broadband RMS voltage fluctuations measured by each configuration caused by the disturbance field produced by the jet as a function of the normalized distance along the beam propagation axis from the instrument's focus. In each data series, the broadband RMS voltage is normalized by its corresponding peak RMS voltage, and the measurement distance from the focus is normalized by the jet diameter at the exit. Comparing the traditional FLDI results to those obtained using a R-FLDI setup with a mirror or a retroreflector, the peak RMS voltage was observed to remain at the respective instrument's focus, regardless of the configuration. That is, the addition of a return pass through the disturbance field in an R-FLDI setup does not seem to appreciably shift the location where the R-FLDI is most sensitive to broadband disturbances. Additionally, for all FLDI variations (traditional and reflective), higher RMS voltages are observed in the direction up beam of the focus (negative values of position). It was also observed that, for a traditional FLDI setup, the RMS voltages captured at the various positions near the focus follow a sawtooth pattern. In comparison, all R-FLDI variations show a steeper fall-off from the peak RMS signal at the focus, suggesting the R-FLDI is less sensitive to disturbances away from the measurement region.

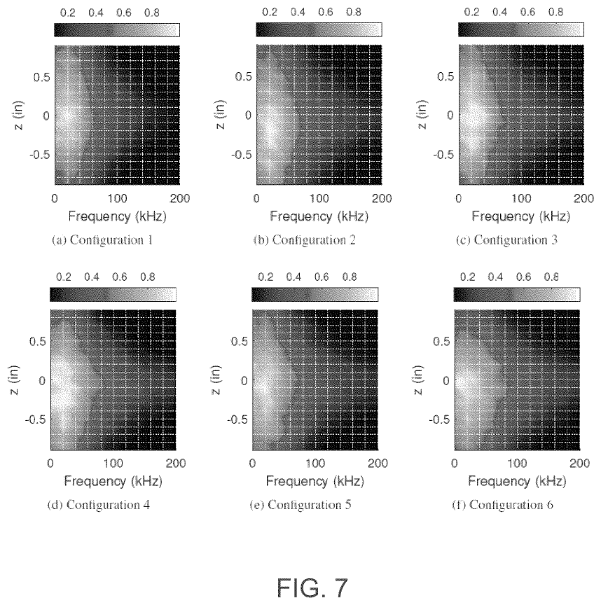

To further compare the traditional and R-FLDI configurations, power spectral densities (PSD) were computed for each measurement gathered. The PSDs were computed using a Welch method with a Hamming window size of 50,000 samples at 50% overlap to provide 1 kHz of spectral resolution. FIG. 7 shows these PSD contour maps for each configuration. These PSDs were normalized by their respective maximum amplitude. The dominant jet frequency of approximately 20 kHz is observed in each spectra. All configurations show a falloff in PSD amplitude at jet locations away from the instrument's focus. However, spectra computed from data collected with R-FLDI configurations show persistent high-frequency spectral content near the instrument's focus.

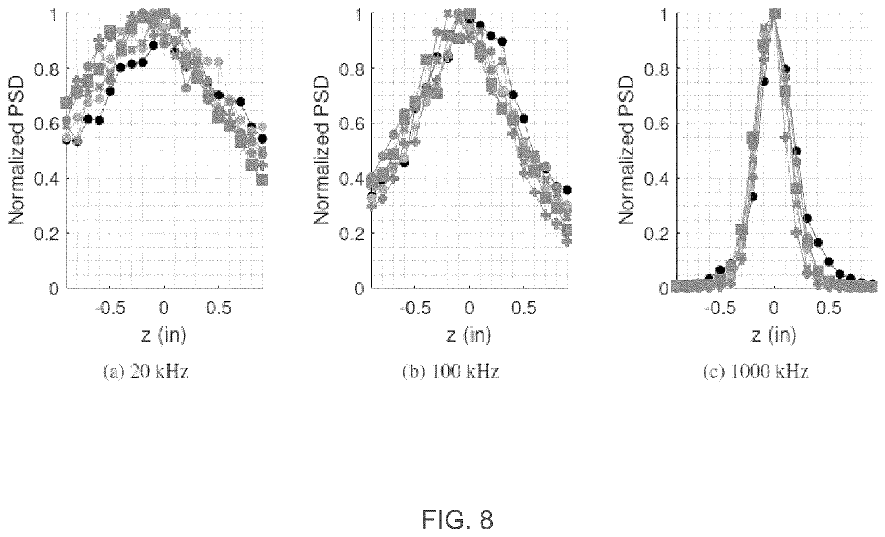

To provide more insight into the differences between the different configurations, the PSD amplitudes at a few distinct frequencies are extracted and plotted against normalized jet distance from the instrument's focus in FIG. 8 . . . . Frequencies of 20, 100, and 1000 kHz are shown in FIGS. 8(a), 8(b), and 8(c), respectively, to show the differences between the different configurations at different frequency regimes. At the dominant jet frequency of 20 kHz, it appears that the R-FLDI configurations have higher normalized PSD amplitudes at negative jet locations along the beam axis (i.e., closer to the pitch side optics). This difference in response at this lower frequency band may be due to the double-pass nature of the R-FLDI configurations. At 100 kHz, it appears that the R-FLDI configurations provide nearly identical PSD amplitudes to the traditional FLDI setup at each jet location with slightly lower PSD amplitudes in the positive jet positions. At 1,000 kHz, the R-FLDI configurations provide slightly higher PSD amplitudes away from the instrument's focus. Regardless of the differences in the spectral responses, the R-FLDI setup provides comparable measurements to traditional FLDI while also providing many new benefits.

It should now be understood that R-FLDI systems can solve one or more problems associated with traditional optical schemes in traditional FLDI systems. As mentioned herein, traditional variants of FLDI require “pitch” optics (the aspects of the optical system associated with generating a beam) and separate “catch” optics (the aspects of the optical system associated with receiving the beam) set up on either side of the measurement location. The R-FLDI systems described herein will eliminate a need for two points of optical access and for such precise alignment between the pitch and catch sides of a traditional FLDI system. Accordingly, the R-FLDI systems and features described herein would solve one or more problems encountered in the current state of the art.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A reflective focused laser differential interferometry (R-FLDI) system comprising:
a light source for generating a beam of light;
a beam expanding optic;
a first linear polarizer;
a quarter-wave plate;
a first birefringent prism;
a beam discriminating optic;
a focusing lens;
a reflector;
a second birefringent prism;
a second linear polarizer; and
a detector, wherein
in a first pass, the beam of light passes through the plano-concave lens, the first linear polarizer, the quarter-wave plate, the first birefringent prism, the beam discriminating optic, and the focusing lens such that it propagates through a measurement location,
after it passes through the measurement location, it is reflected by the reflector such that it passes through the focusing lens and is redirected by the beam discriminating optic through the second birefringent prism and a second linear polarizer and is detected by the detector.

2. The R-FLDI system of claim 1, wherein the beam expanding optic is a plano-concave lens.

3. The R-FLDI system of claim 1, wherein the first birefringent prism and the second birefringent prism are made from one or more anisotropic materials.

4. The R-FLDI system of claim 3 wherein the anisotropic materials include one or more of calcite (CaCO₃), quartz (SiO₂), and magnesium fluoride (MgF₂).

5. The R-FLDI system of claim 1, wherein one or more of the first birefringent prism and the second birefringent prisms is one or more of a Glan-Taylor prism, a Rochon prism, and a Differential Interference Contrast Prism.

6. The R-FLDI system of claim 1, wherein the beam discriminating optic includes one or more specialized coatings or materials that provide equal or near-equal reflection and transmission for both polarization states across a particular wavelength range.

7. The R-FLDI system of claim 6, wherein the coatings comprise alternating layers of materials with different refractive indices.

8. The R-FLDI system of claim 6, wherein the materials include silicon dioxide (SiO₂) and titanium dioxide (TiO₂).

9. The R-FLDI system of claim 1, wherein the reflector is a specular reflector or a specular retroreflector.

10. A method of measuring optical path length differences using a R-FLDI system, the method comprising:
directing a spectrally narrow, diverging, continuous wave laser beam in a circular polarization state of arbitrary handedness along a primary optical axis in a first direction;
separating the circularly polarized beam into a linearly polarized beam pair with orthogonal polarization through the first birefringent prism in the first direction;
passing the linearly polarized beam pair through a focusing lens in the first direction;
passing the converging, polarized beams of the beam pair through a measurement region a first time in the first direction;
reflecting the diverging, polarized beam pair back along the primary optical axis in a second direction;
passing the reflected diverging, polarized beam pair through a measurement region a second time in the second direction;
passing the reflected, diverging, polarized beam pair a second time through a focusing lens in the second direction;
diverting the reflected, converging beam pair along a secondary optical axis that is at an angle from the primary optical axis;
combining the diverted beam pair into a single beam with orthogonal polarization states using a second birefringent prism along the secondary optical axis;
projecting the orthogonal polarization states of the recombined, single beam onto the same polarization axis using a polarizing optic along the secondary optical axis;
measuring the intensity of the diverted, combined beam.

11. The method of measuring optical path length differences of claim 10, wherein directing a spectrally narrow, diverging, continuous wave laser beam in a circular polarization state of arbitrary handedness along an optical axis includes projecting light rays from a light source and expanding and circularly polarizing the light rays with an arbitrary handedness.

12. The method of measuring optical path length differences of claim 2, wherein the light source projects the light rays along the first optical axis, and further diverts the light rays from the primary optical axis to the secondary optical axis using a discriminating optic that separates the returning beam pair from the incident beam pair.

13. The method of measuring optical path length differences of claim 10, wherein separating the circularly polarized beam into a linearly polarized beam pair includes passing the beam through the first birefringent prism.

14. The method of measuring optical path length differences of claim 13, wherein the first birefringent prism is, for example, one of a Wollaston prism, a Sanderson prism, a Rochon prism, or a Nomarski prism, made from one or more anisotropic materials such as calcite (CaCO₃), quartz (SiO₂), and magnesium fluoride (MgF₂).

15. The method of measuring optical path length differences of claim 10, wherein passing the linearly polarized beam pair through a focusing lens includes passing the beam through a plano-convex or bi-convex lens.

16. The method of measuring optical path length differences of claim 1, wherein reflecting the polarized beam pair back along the optical axis includes reflecting the polarized beam pair off a reflector.

17. The method of measuring optical path length differences of claim 16, wherein the reflective surface is positioned in the path of the polarized beam pair.

18. The method of measuring optical path length differences of claim 16, wherein the reflective surface is located after the measurement region.

19. The method of measuring optical path length differences of claim 18, wherein the discriminating optic may be a non-polarizing beam splitter or a pick-off mirror.

20. The method of measuring optical path length differences of claim 10, wherein diverting the reflected beam pair along a second optical axis includes passing the reflected beam pair through a discriminating optic that separates the returning beam pair from the incident beam pair.
